(19) United States
(12) Patent Application Publication
(10) Pub. No.: US 2026/0219038 A1
(43) Pub. Date: Jul. 30, 2026

(54) PROCESS FOR DETERMINING THE ROUGHNESS OF A ROADWAY SURFACE AND SENSOR DEVICE FOR CARRYING OUT THE PROCESS

(71) Applicant: Kistler Holding AG, Winterthur (CH)

(72) Inventor: Gabriel Winterstein, Herrenberg (DE)

(21) Appl. No.: 19/454,675

(22) Filed: Jan. 21, 2026

(30) Foreign Application Priority Data
Jan. 24, 2025 (EP) 25153726.2

(51) Int. Cl. G01B 11/30; G01D 18/00

(52) U.S. Cl. CPC G01B 11/303; G01D 18/008

(57) ABSTRACT

A process for determining the roughness of a surface of a roadway uses a sensor device attached to a vehicle traveling on the surface. The sensor device includes a photodetector that images a portion of the surface while the vehicle moves over the roadway's surface. The photodetector generates measurement signals from the image. In a first step the measurement signals are provided as measurement data that include an intensity containing information about the roughness of the surface and information about the light intensity of the surface. The intensity is defined by an amplitude and an offset.

### FIELD OF THE INVENTION

The invention relates to a process for determining the roughness of a roadway surface as well as to a sensor device for carrying out the process.

### BACKGROUND OF THE INVENTION

A sensor device for measuring a relative movement between a vehicle and a roadway is known from EP0101536A1, which corresponds to US Patent No. 4,605,308 that is hereby incorporated in its entirety herein by this reference for all purposes. Specifically, the sensor device is used for measuring the speed and the direction of travel of the vehicle on the roadway. For this purpose, the sensor device is attached to the vehicle. The sensor device comprises photodetectors. The photodetectors are laid out in a lattice-like structure and are arranged with respect to each other at a photodetector angle. Each photodetector comprises a plurality of photodiodes. During movement of the vehicle, a portion of the surface of the roadway is imaged onto the photodetectors and captured by the plurality of photodiodes. The photodiodes generate measurement signals for the captured portion of the roadway surface. Furthermore, the prior art sensor device comprises an evaluation unit for evaluating the measurement signals and for determining, on the basis of the evaluation of the measurement signals, the speed or direction, respectively, of the relative movement of the sensor device with respect to the roadway.

Now, it is desired by vehicle users to be aware of the roughness of the roadway surface. The reason is that the roughness has a major impact on the functional characteristics of the roadway, such as performance, safety, convenience, and economic efficiency. Thus, the roughness of the surface has an impact on the grip and noise emissions of the vehicle's tires on the roadway. The surface roughness may be fine or coarse. A fine surface roughness reduces the grip of the tires which particularly affects driving at high speeds and driving through bends. In contrast, a coarse roughness of the surface increases the grip of the tires having a strong influence on driving on wet roadways and aquaplaning.

### OBJECTS AND SUMMARY OF THE INVENTION

It is the object of the present invention to further develop the prior art sensor device. In particular, the sensor device shall be capable of determining the roughness of the roadway surface.

This object has been achieved by the features described herein.

The invention relates to a process for determining the roughness of a roadway surface using a sensor device attached to a vehicle. The sensor device includes a light source and at least one photodetector configured and disposed to detect light reflected from the roadway surface as the vehicle is moved over the roadway surface. The reflected light includes light originating from the light source and light from the environment, which is variable depending on numerous conditions like time of day, weather conditions, overhead street lighting, light coming from other vehicles whether from headlights or just reflected off other vehicles and other reflective surfaces in the environment, etc. While the roughness of the road surface is difficult to correlate with the detected intensity of the reflected light, such correlation has been identified with the value of the lattice constant of the sensor device in accordance with the present invention. Thus, during the vehicle's movement, a portion of the surface is imaged onto the photodetector, and the photodetector is used to generate measurement signals from the image. The measurement signals are provided as measurement data, said measurement data having an intensity, which intensity contains information regarding the roughness of the surface and information regarding the intensity of the light being reflected from the roadway surface. The intensity of the measurement data is composed of an amplitude and an offset that can be provided as inputs to the vehicle's other systems such as an anti-lock braking systems as one example or tire pressure warning systems as another example.

Moreover, the invention relates to a sensor device for carrying out the process for determining the roughness of a roadway surface; said sensor device comprising at least one photodetector; wherein said sensor device can be attached to a vehicle and, when attached to the vehicle, can be moved by the vehicle over the roadway surface whereby a portion of the surface is imaged onto the photodetector as an image; wherein the photodetector generates measurement signals from the image; said sensor device comprising at least an evaluation unit, which evaluation unit converts the measurement signals into measurement data; wherein the evaluation unit comprises at least an evaluation program, which evaluation program is configured to load and evaluate said measurement data; wherein the measurement data comprises an intensity, which intensity contains information regarding the roughness of the surface and information regarding the intensity of the light being reflected from the roadway surface; and wherein the intensity of the measurement data is composed of an amplitude and an offset.

Advantageous further developments of the invention are described in greater detail below.

### BRIEF DESCRIPTION OF THE DRAWINGS

In the following, the invention will be explained in more detail by way of example referring to the figures that are briefly described below.

FIG. 1 shows a side view of a portion of a sensor device 10 attached to a vehicle 1 on a surface 2 having a roughness R.

FIG. 2 shows views of portions of the surface 2 of the roadway 3 according to FIG. 1 having different roughnesses R2 - R2"'.

FIG. 3 shows a schematic representation of a portion of a first embodiment of the sensor device 10 according to FIG. 1 with details regarding the imaging of the surface 2 onto a photodetector 14, 15.

FIG. 4 shows a schematic representation of a portion of a second embodiment of the sensor device 10 according to FIG. 1 with details regarding the imaging of the surface 2 onto a photodetector 14, 15.

FIG. 5 shows a schematic representation of a portion of a third embodiment of the sensor device 10 according to FIG. 1 with details regarding the imaging of the surface 2 onto a photodetector 14, 15.

FIG. 6 shows a schematic representation of a portion of the first embodiment of the sensor device 10 according to FIG. 3 with details regarding the generation of measurement data D14, D15 of the surface 2 imaged.

FIG. 7 shows a schematic representation of a portion of the second embodiment of the sensor device 10 according to FIG. 4 with details regarding the generation of measurement data D14, D15 and light intensity data D17 of the surface 2 imaged

FIG. 8 shows a schematic representation of a portion of the third embodiment of the sensor device 10 according to FIG. 5 with details regarding the generation of measurement data D14, D15 and light intensity data D17'of the surface 2 imaged.

FIG. 9 shows a representation of measurement data D14, D15 of the surface 2 imaged that has a first roughness R2 according to FIG. 2.

FIG. 10 shows a representation of first and second measurement data D14, D15 of the surface 2 imaged that has a second roughness R2' according to FIG. 2.

FIG. 11 shows a representation of first and second measurement data D14, D15 of the surface 2 imaged that has a third roughness R2" according to FIG. 2.

FIG. 12 shows a representation of first and second measurement data D14, D15 of the surface 2 imaged that has a fourth roughness R2"' according to FIG. 2.

FIG. 13 shows a flowchart comprising the steps S1-S5 of a first variation of the process for determining the roughness R of the surface 2 according to FIG. 1 using the sensor device 10 according to FIGS. 3 to 8.

FIG. 14 shows a flow chart comprising the steps SS1 - SS8 of a second variation of the process for determining the roughness R of the surface 2 according to FIG. 1 using the sensor device 10 according to FIGS. 3 to 8.

Throughout the figures, the same reference numerals indicate the same objects.

### DETAILED DESCRIPTION OF EXEMPLARY EMBODIMENTS OF THE INVENTION

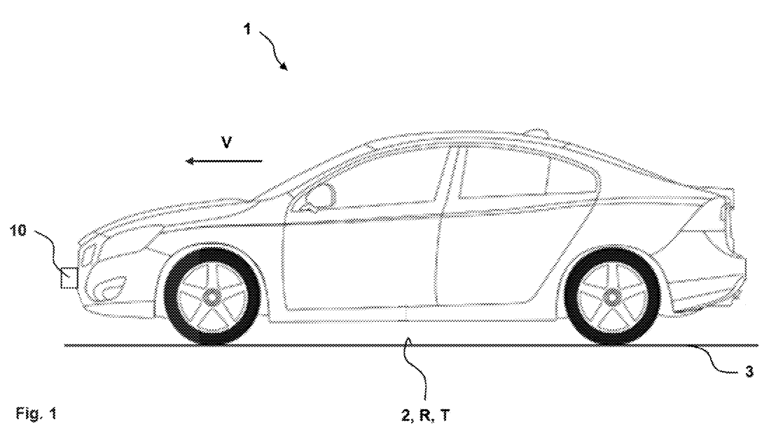

FIG. 1 shows a side view of a portion of a sensor device 10 attached to a vehicle 1.

The sensor device 10 is installed at the front of the vehicle that is generally indicated by the numeral 1 in FIG. 1, for example. Vehicle 1 moves on a roadway 3 at a speed V, as schematically represented in FIG. 1. Roadway 3 comprises a surface 2 on which the vehicle 1 travels. A direction of movement is shown by an arrow beneath the designation V. The sensor device 10 has the function to measure a roughness R of the surface 2 and provide in real time, such roughness information on which the vehicle's systems can base adjustments to be implemented for better operation of the vehicle.

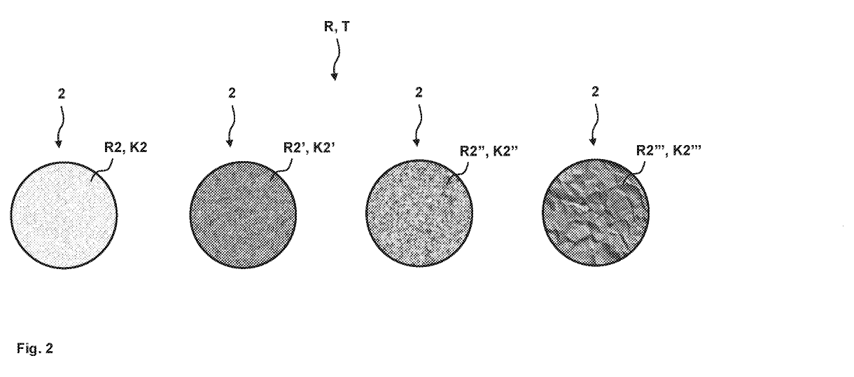

The surface 2 of the roadway 3 has a roughness R. The roughness R indicates the unevenness in height of the surface 2 perpendicular to its planar extension. The roughness R of the surface 2 is stochastic and comprises a more or less large structure K. In this respect, FIG. 2 exemplarily shows four surfaces 2 each having a different roughness R and structures K of different sizes. The roughness R comprises a first roughness R2 with first structures K2, a second roughness R2' with second structures K2', a third roughness R2" with third structures K2", and a fourth roughness R2"' with fourth structures K"'. The first roughness R2 comprises small first structures K2 having heights in the range of greater than/equal to 20 up to equal to 200 µm. The second roughness R2' comprises larger second structures K2' having heights in the range of greater than/equal to 200 up to equal to 500 µm. The third roughness R2" comprises large third structures K2" having heights in the range of greater than/equal to 500 up to equal to 1000 µm. The fourth roughness R2"' comprises very large fourth structures K2"' having heights in the range of greater than/equal to 1000 up to equal to 2000 µm. In light of the present invention, the roughness may have more than four sizes of structures. Furthermore, the roughness may also show other sizes of structures, such as smaller and still larger structures.

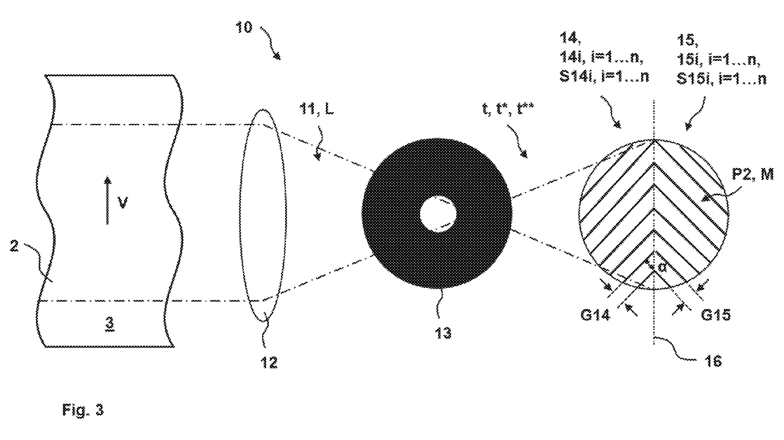

FIGS. 3 to 8 show details with respect to the sensor device 10. The sensor device 10 is configured to detect light 11 that is reflected from the surface 2. The reflected light can consist solely of light sourced from the environment, whether natural light like sunlight or artificial light from street lights for example. However, optionally, the sensor device 10 can include a light source that augments the light from the environment. In FIGS. 2 to 4, edge rays of the light 11 are shown as dash-dotted lines. The sensor device 10 comprises at least one optical lens 12, at least one aperture 13, and at least one photodetector 14, 15. From the surface 2, the light 11 travels to the optical lens 12 by which it is focused onto the aperture 13. From the aperture 13, the light 11 travels to the photodetector 14, 15. The surface 2 is imaged onto the photodetector 14, 15 as the image P2. The image of the surface 2 on the photodetector 14, 15 is produced with an image scale M.

Preferably, the photodetector 14, 15 comprises a first photodetector 14 and a second photodetector 15. Each of the photodetectors 14, 15 is shaped as a lattice wherein the first photodetector 14 is defined by a first lattice constant G14, the second photodetector 15 is defined by a second lattice constant G15. An axis of symmetry 16 extends between the photodetectors 14, 15. As schematically shown in FIG. 3, the photodetectors 14, 15 desirably are arranged with respect to the axis of symmetry 16 at a photodetector angle a of 45°. The axis of symmetry 16 extends parallel to a longitudinal axis of the vehicle 1. However, in light of the present invention, the photodetector angle a may also be of any other value, thus, its value may be 30° or 60°.

The photodetector 14, 15 comprises a plurality n of photodiodes 14i, 15i, i=1...n, where the index i is an integer between 1 and n. Preferably, the plurality is equal to ten, one hundred, etc. The first photodetector 14 comprises a plurality n of first photodiodes 14i, i=1...n. The first photodiodes 14i, i=1...n, are arranged at a distance to each other, i.e., at a distance between adjacent photodiodes, that is equal to the first lattice constant G14. The second photodetector 15 comprises a plurality n of second photodiodes 15i, i=1...n. The second photodiodes 15i, i=1...n, similarly are arranged at a distance to each other that is equal to the second lattice constant G15. The value of the lattice constant G14, G15 may be adjusted. Preferably, the value of the lattice constant G14, G15 is in the range of the roughness R2 - R2"' of the surface 2. Preferably, the value of the lattice constant G14, G15 is equal to 400 µm.

The photodetector 14, 15 constitute a spatial frequency filter where onto each of the plurality n of photodiodes 14i, 15i, i=1...n, is imaged only a portion of the surface 2. Each of the plurality n of photodiodes 14i, 15i, i=1...n, generates a measurement signal S14i, S15i, i=1...n for the portion it detects. The first photodiodes 14i, i=1...n, generate first measurement signals S14i, i=1...n. The second photodiodes 15i, i=1...n, generate second measurement signals S15i, i=1...n. The measurement signals S14i, S15i, i=1...n, generated by the photodiodes are analog signals.

The sensor device 10 is configured to generate the measurement signals S14i, S15i, i=1...n, at different time points t*, t** of the time t while the vehicle 1 is driving on the roadway 3. The time points t*, t** comprise a first time point t* and at least one further time point t**. The time points t*, t** occur depending on a measurement frequency of the sensor device 10. Preferably, the measurement frequency of the sensor device 10 is between 500 kHz and 1 MHz. Thus, the further time point t** occurs at least 10-⁶ sec later than the first time point t*. Thus, during a measurement of the roughness R of the surface 2 which takes 10-³ sec, for example, there are 103 further time points t**.

In the manner described below, the sensor device 10 is configured so that the measurement signals S14i, S15i, i=1...n, are tapped at several signal outputs according to an alternating weighting between odd-numbered photodiodes and even numbered photodiodes.

First even-numbered measurement signals S14ip, i=2...n, are tapped at a first signal output of the first photodetector 14. The first even-numbered measurement signals S14ip are derived from first photodiodes 14i having an even-numbered index i=2...n. Because the first photodiodes 14i have different even-numbered indices i, the first even-numbered measurement signals S14ip, i=2...n, are phase-shifted relative to each other by a phase shift. For the photodetector angle a of 45° with respect to the axis of symmetry 16, the phase shift is 90°.

First odd-numbered measurement signals S14iu, i=1...n, are tapped at a second signal output of the first photodetector 14. The first odd-numbered measurement signals S14iu, i=1...n, are derived from first photodiodes 14i having an odd-numbered index i=1... n. Because the first photodiodes 14i have different odd-numbered indices i, the first odd-numbered measurement signals Si14u, i=1...n, are phase-shifted relative to each other by the phase shift that is dependent on the photodetector angle a.

Second odd-numbered measurement signals S15iu, i=1...n, are tapped at a second signal output of the second photodetector 15. The second odd- numbered measurement signals S15iu, i=1...n, are derived from second photodiodes 15i having an odd-numbered index i=1... n. Because the second photodiodes 15i have different odd-numbered indices i, the second odd- numbered measurement signals S15iu, i=1...n, are phase-shifted relative to each other by the phase shift that is dependent on the photodetector angle a.

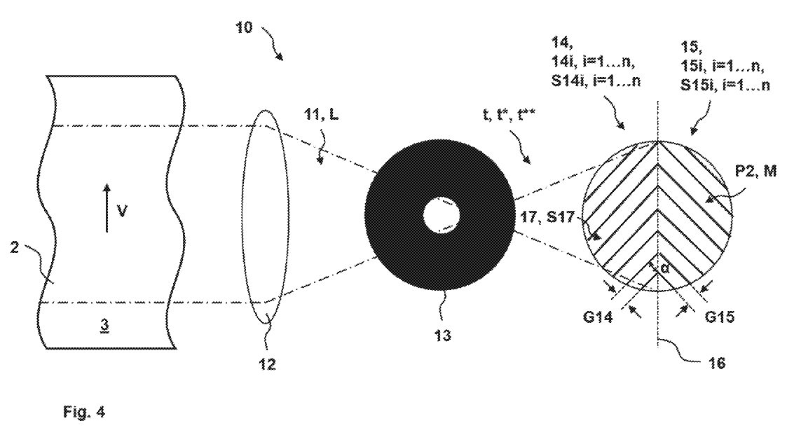

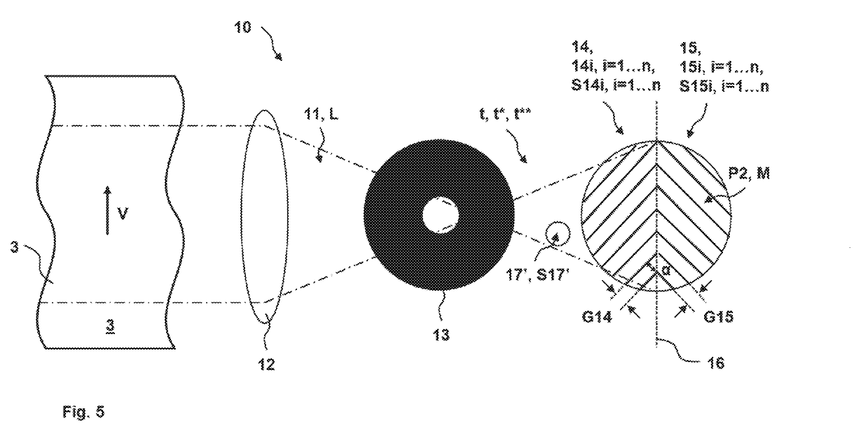

As schematically shown in FIGS. 4, 5 and 7, the sensor device 10 may comprise a light intensity photodiode 17, 17' among the photodiodes 14, 15. Such a light intensity photodiode 17, 17' is not strictly required for determining the roughness R2 - R2"' of the surface 2 of the roadway 3. Thus, the photodetector 14, 15 of the first embodiment of the sensor device 10 according to FIG. 3 does not comprise a light intensity photodiode. In the embodiment of FIG. 3, the absence of any light intensity information provided by a light intensity photodiode 17, 17' means that the roughness R of the surface 2 of the roadway 3 is estimated from the change in time of the amplitude A, as described hereinafter. However, the sensor device 10 according each of the second and third embodiments as shown in FIGS. 4 and 5 comprises at least one light intensity photodiode 17, 17' in the photodetector 14, 15. The light intensity photodiode 17, 17' has the sole function of measuring a light intensity L of the light 11 that provides information enabling a more precise determination of the roughness R of the surface 2 of the roadway 3, as described hereinafter.

In the second embodiment of the sensor device 10 according to FIG. 4, the light intensity photodiode 17 is a component of one of the photodetector 14, 15. Thus, the light intensity photodiode 17 is one of the plurality n of photodiodes 14i, 15i, i=1...n, arranged with respect to each other at a distance that is equal to the lattice constant G14, G15.

In the third embodiment of the sensor device 10 according to FIG. 5, the light intensity photodiode 17' is not a component of the photodetector 14, 15. The light intensity photodiode 17' is a separate member in addition to the plurality n of photodiodes 14i, 15i, i=1...n, that is arranged spatially spaced apart from the plurality n of photodiodes 14i, 15i, i=1...n.'''''''''''

The light intensity photodiode 17, 17' is configured to generate a light intensity signal S17, S17'having a magnitude proportional to the intensity of the light incident on the photodiode 17, 17' . The light intensity signal S17, S17' is an analog signal.

The sensor device 10 comprises at least an evaluation unit 20. The evaluation unit 20 is configured to perform the function of evaluating the measurement signals S14i, S15i, i=1...n and the light intensity signal S17, S17'. For this purpose, the evaluation unit 20 is configured to convert the analog measurement signals S14i, S15i, i=1...n, and the analog light intensity signal S17, S17' into digital measurement data D14, D15 and digital light intensity data D17.

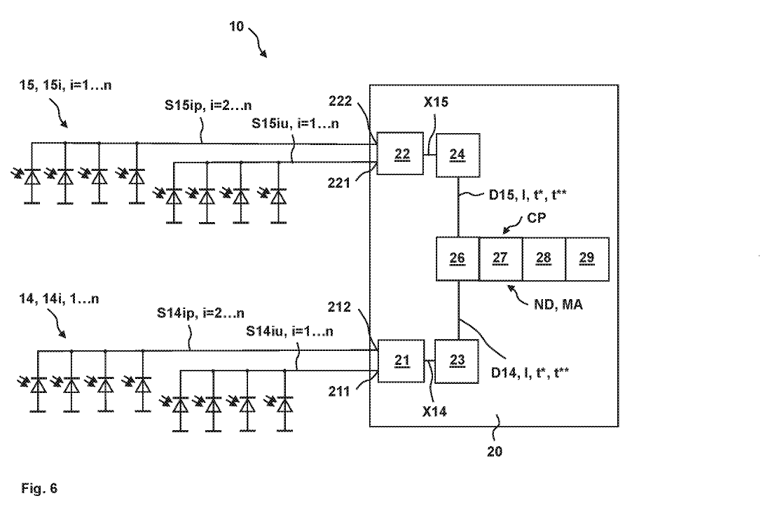

The evaluation unit 20 is configured to receive the measurement signals S14i, S15i, i=1...n, from the plurality n of first and second photodiodes 14i, 15i, i=1... n. To this end, the plurality n of first photodiodes 14i, i=1...n, and the evaluation unit 20 are electrically connected in the embodiments of the sensor device 10 according to the schematic representation of FIGS. 6 to 8. In addition, the plurality n of second photodiodes 15i, i=1...n, and the evaluation unit 20 are also electrically connected according to the schematic representation of FIGS. 6 to 8.

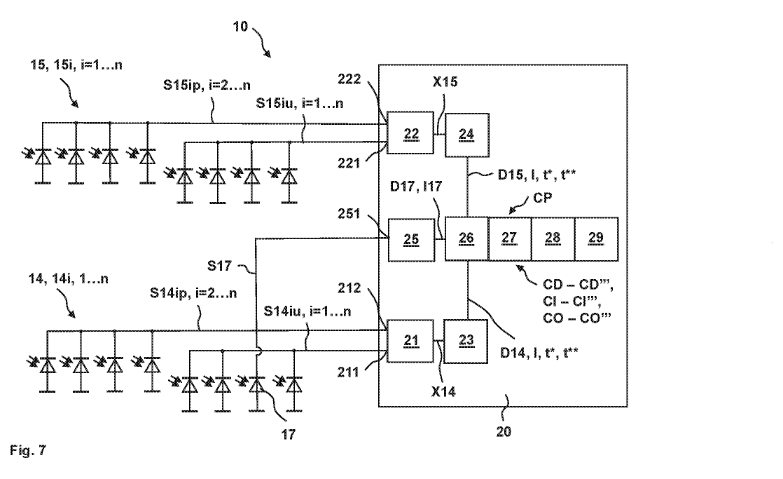

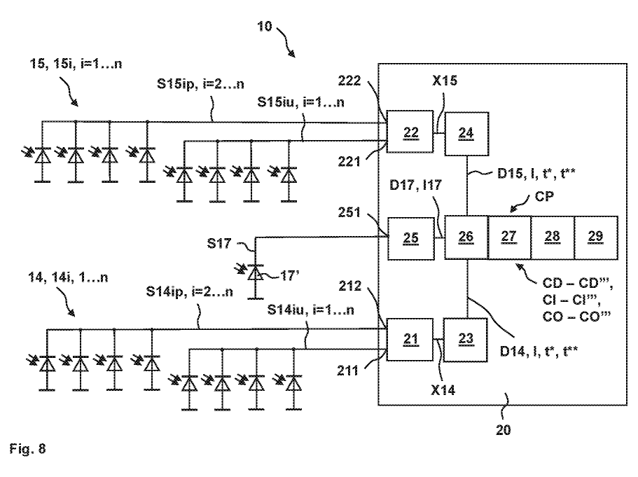

The evaluation unit 20 is configured to receive the light intensity analog measurement signal S17, S17' from the light intensity photodiode 17, 17'. To this end, the light intensity photodiode 17, 17' and the evaluation unit 20 are electrically connected in the embodiments of the sensor device 10 according to FIGS. 7 and 8.

The evaluation unit 20 comprises at least a subtractor 21, 22, at least an analog-to-digital converter 23, 24, 25, at least a data processor 26, at least a data memory 27, at least an input device 28, and at least an output device 29. Furthermore, the evaluation unit 20 comprises several signal inputs 211, 212, 221, 222, 251. The subtractors 21, 22 comprise a first subtractor 21 and a second subtractor 22. The analog-to-digital converters 23, 24, 25 comprise a first analog-to-digital converter 23, a second analog-to-digital converter 24, and a third analog-to-digital converter 25.

In the embodiments of the sensor device 10 shown schematically in FIGS. 6 to 8, the first measurement analog signals S14i, i=1...n, are applied to the first of the signal inputs 211, 212 of the evaluation unit 20. The first measurement analog signals S14i, i=1...n, comprise first even-numbered and odd-numbered measurement analog signals S14ip, S14iu, i=1... n. The first subtractor 21 is configured to subtract the first even-numbered and odd-numbered measurement signals S14ip, S14iu, i=1...n, to obtain first differences in potential X14. The first analog-to-digital converter 23 is configured to digitize the first differences in potential X14 to give first measurement digital data D14 that is in a format that can be processed by the data processor 26.

In the embodiments of the sensor device 10 shown in FIGS. 6 to 8, the second measurement analog signals S15i, S15i, i=1...n, are applied at second signal inputs 221, 222 of the evaluation unit 20. The second measurement analog signals S15i, i=1...n, comprise second even-numbered and odd-numbered measurement analog signals S15i+, S15i-, i=1... n. The second subtractor 22 is configured to subtract the second even-numbered and odd-numbered measurement signals S15i+ S15i-, i=1...n, to obtain second differences in potential X15. The second analog-to-digital converter 24 is configured to digitize the second differences in potential X15 to give second measurement analog data D15 that is in a format that can be processed by the data processor 26.

The measurement digital data D14, D15 are derived from measurement analog signals S14i, S15i, i=1...n generated by the sensor device 10 at different time points t*, t**.

The measurement digital data D14, D15 comprise an intensity I. The measurement digital data D14, D15 are provided in a format that can be stored in the data memory 27.

In the embodiments of the sensor device 10 according to FIGS. 7 and 8, the light intensity analog signal S17, S17' is applied to the third signal input 251 of the evaluation unit 20 and is digitized by the third analog-to-digital converter 25 to give light intensity digital data D17. The light intensity digital data D17 comprise a light intensity 117. The light intensity digital data D17 is formatted so as to be able to be stored in the data memory 27.

The evaluation unit 20 comprises at least an evaluation program CP that is stored in the data memory 27 and that can be loaded into the data processor 26. The evaluation program CP loaded into the data processor 26 is configured to evaluate the measurement digital data D14, D15 and the light intensity digital data D17.

The evaluation program CP loaded into the data processor 26 is configured to load the measurement digital data D14, D15 into the data processor 26 and to evaluate them by the intensity I over the time t.

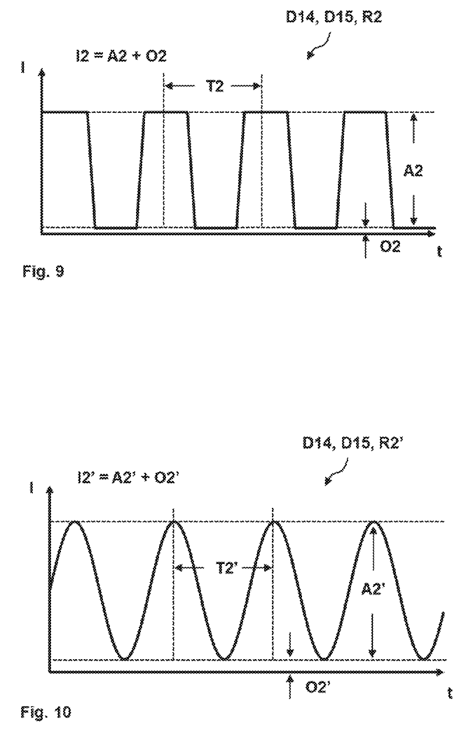

FIGS. 9 to 12 show representations of the measurement data D14, D15 obtained from the surface 2 with different roughnesses R2 - R2"'. In the diagrams, the intensity I is plotted as the ordinate against the time t on the abscissa. The intensity I is defined by an amplitude A and an offset O. The intensity I comprises a first intensity 12, a second intensity 12', a third intensity 12" and a fourth intensity 12"'.

FIG. 9 shows the measurement data D14, D15 of the surface 2 having the first roughness R2. With first structures K2 in the range of greater than/equal to 20 up to equal to 200 µm, the first roughness R2 is significantly smaller than the lattice constant G14, G15 which is 400 µm. The measurement data D14, D15 are rectangular in shape and defined by a first intensity 12 and a first period length T2. The first intensity 12 is defined by a first amplitude A2 and a first offset 02.

FIG. 10 shows the measurement data D14, D15 of the surface 2 having the second roughness R2'. With second structures K2' in the range of greater than/equal to 200 up to equal to 500 µm, the second roughness R2' is in the order of the lattice constant G14, G15 of 400 µm. The measurement data D14, D15 are sinusoidal in shape and defined by a second intensity 12' and a second period length T2'. The second intensity 12' is defined by a second amplitude A2' and a second offset 02'. The second amplitude A2' is larger compared to the first amplitude A2. The second offset 02' is larger compared to the first offset 02.

FIG. 11 shows the measurement data D14, D15 of the surface 2 having the third roughness R2". With third structures K2" in the range of greater than/equal to 500 up to equal to 1000 µm, the third roughness R2" is greater than the lattice constant G14, G15 of 400 µm. The measurement data D14, D15 are sinusoidal in shape and defined by a third intensity 12" and a third period length T2". The third intensity 12" is defined by a third amplitude A2" and a third offset 02". The third amplitude A2' is smaller compared to the first amplitude A2 and the second amplitude A'. The third offset 02" is larger compared to the first offset 02 and the second offset 02'.

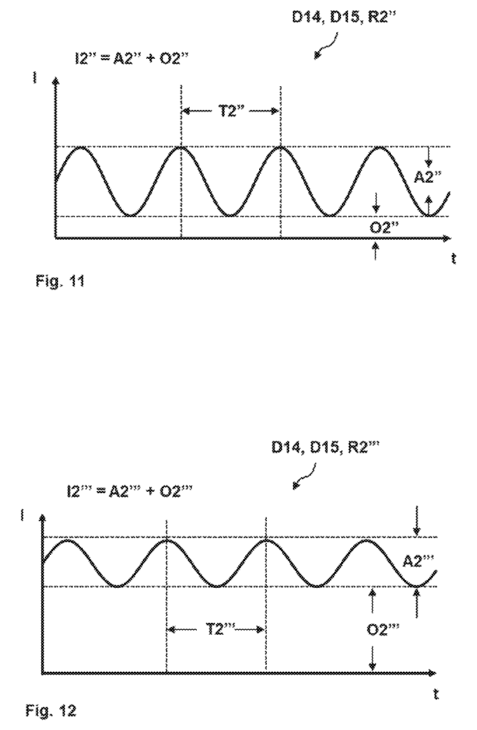

FIG. 12 shows the measurement data D14, D15 of the surface 2 having the fourth roughness R2"'. With fourth structures K2"' in the range of greater than/equal to 1000 up to equal to 2000 µm, the fourth roughness R2"' is significantly greater than the lattice constant G14, G15 of 400 µm. The measurement data D14, D15 are sinusoidal in shape and defined by a fourth intensity 12"' and a fourth period length T2"'. The fourth intensity 12"' is defined by a fourth amplitude A2"' and a fourth offset 02"'. The fourth amplitude A2"' is smaller compared to the first amplitude A2, the second amplitude A", and the third amplitude A". The fourth offset 02"' is larger compared to the first offset 02, the second offset 02', and the third offset O".

In accordance with the present invention, the value of the lattice constant G14, G15 of the sensor device 10 bears a useful relationship to the roughness R of the surface 2 of the roadway 3 being detected. From the representations of the measurement data D14, D15 of the surface 2 with different roughnesses R2 - R2"' according to FIGS. 9 to 12 the following conclusions can be drawn:

For a roughness R in the range of the value of the lattice constant G14, G15 the amplitude A becomes maximum.

For a roughness R that is smaller than the lattice constant G14, G15 the offset O is small.

For a roughness R that is greater than the lattice constant G14, G15 the offset O increases with the size of the structures K of the roughness R.

The intensity 12 - 12"' contains information on the roughness R2 - R2"' of the surface 2 and information on the light intensity L of the surface 2. These two pieces of information overlie each other in the intensity 12 - 12"'. The information on the light intensity L of the surface 2 interferes with and hinders the determination of the roughness R2 - R2"' of the surface 2. For this reason, the information on the light intensity L of the surface 2 is desirably eliminated from the intensity 12 - 12"'. The evaluation unit 20 comprises a plurality of normalization data ND and calibration data CD - CD"' for achieving this elimination of undesirable effects attributable to the light intensity of the surface.

The normalization data ND are stored in the data memory 27. The normalization data ND comprise a maximum amplitude MA for the sensor device 10. The maximum amplitude MA is the maximum amplitude that the analog-to- digital converter 23, 24 is able to process when digitizing the differences in potential X14, X15.

The calibration data CD - CD"' are stored in the data memory 27. The calibration data CD - CD"' contain information for different roughnesses R2 - R2"' of a surface 2 such as the size of the structures K2 - K2"' thereof as well as calibration intensities CI - CI"'. Each calibration intensity CI - CI"' is composed of a calibration amplitude CA - CA"' and a calibration offset CO - CO"'. The calibration intensities CI - CI"' do not contain any information regarding the light intensity L of the surface 2.

The first calibration data CD indicate the size of the first structures K2 according to FIG. 2 which are in the range of greater than/equal to 20 up to equal to 200 µm of the first roughness R2 according to FIG. 2. The first calibration data CD also indicate the amount and the shape of a first calibration amplitude CA for a surface 2 having the first roughness R2. The first calibration data CD also indicate the amount of a first calibration offset CO for a surface 2 having the first roughness R2 with first structures K2 in the range of greater than/equal to 20 up to equal to 200 µpm. The first calibration amplitude CA and the first calibration offset 02 give a first calibration intensity CI. Thus, the first calibration amplitude CA corresponds to the first amplitude A2 according to FIG. 9, and the first calibration offset 02, thus, corresponds to the first offset 02 according to FIG. 9.

The second calibration data CD' indicate the size of the second structures K2' according to FIG. 2 in the range of greater than/equal to 200 up to equal to 500 pm of the second roughness R2' according to FIG. 2. The second calibration data CD' also indicate the amount and the shape of a second calibration amplitude CA' for a surface 2 having the second roughness R2'. Furthermore, the second calibration data CD' indicate the amount of a second calibration offset CO' for a surface 2 having the second roughness R2' with second structures K2' in the range of greater than/equal to 200 up to equal to 500 µm. The second calibration amplitude CA' and the second calibration offset 02' give a second calibration intensity CI'. The second calibration amplitude CA', thus, corresponds to the second amplitude A2' according to FIG. 10, and the second calibration offset 02', thus, corresponds to the second offset 02' according to FIG. 10.

The third calibration data CD" indicate the size of the third structures K2" according to FIG. 2 in the range of greater than/equal to 500 up to equal to 1000 µm of the third roughness R2" according to FIG. 2. The third calibration data CD" further indicate the amount and the shape of a third calibration amplitude CA" for a surface 2 having the third roughness R2". The third calibration data CD" also indicate the amount of a third calibration offset CO" for a surface 2 having the third roughness R2" with third structures K2" in the range of greater than/equal to 500 up to equal to 1000 µm. The third calibration amplitude CA" and the third calibration offset 02" give a third calibration intensity CI". Thus, the third calibration amplitude CA" corresponds to the third amplitude A2" according to FIG. 11, and the third calibration offset 02", thus, corresponds to the third offset 02" according to FIG. 11.

The fourth calibration data CD"' indicate the size of the fourth structures K2"' according to FIG. 2 in the range of greater than/equal to 1000 up to equal to 2000µm of the fourth roughness R2"' according to FIG. 2. Furthermore, the fourth calibration data CD"' indicate the amount and the shape of a fourth calibration amplitude CA"' for a surface 2 having the fourth roughness R2"'. The fourth calibration data CD"' also indicate the amount of a fourth calibration offset CO"' for a surface 2 having the fourth roughness R2"' with fourth structures K2"' in the range of greater than/equal to 1000 up to equal to 2000 µm. The fourth calibration amplitude CA"' and the fourth calibration offset 02"' give a fourth calibration intensity CI"'. The fourth calibration amplitude CA"', thus, corresponds to the fourth amplitude A2"' according to FIG. 12, and the fourth calibration offset 02"', thus, corresponds to the fourth offset 02"' according to FIG. 12.

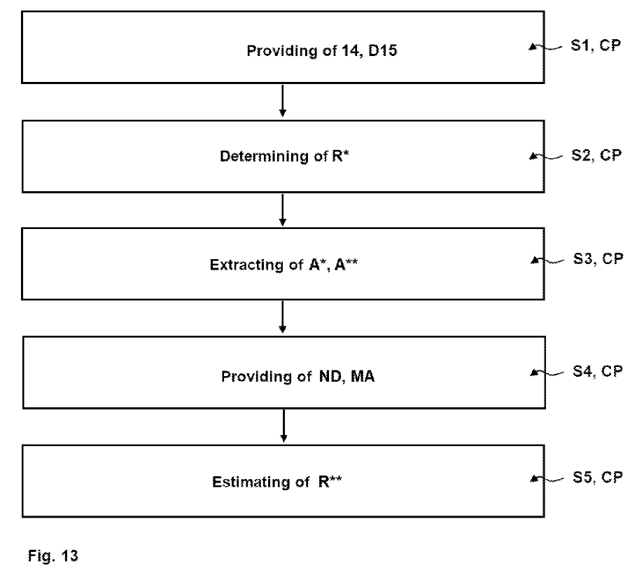

FIG. 13 shows a flow chart comprising the steps S1 - S5 of a first variation of the process for determining the roughness R of the surface 2 using the sensor device 10. In the first variation of the process, the roughness R of the surface 2 is determined only from the amplitude A of the measurement data D14, D15 of the surface 2. To this end, a relative change in the amount of the amplitude A of the measurement data D14, D15 of the surface 2 is used to infer a change in the roughness R of the surface 2. Steps S1-S5 of the first variation of the process comprise a first step S1, a second step S2, a third step S3, a fourth step S4 and a fifth step S5.

In the first step S1, measurement data D14, D15 of the surface 2 are provided. For this purpose, the evaluation program CP loaded into the data processor 26 is configured to load the measurement data D14, D15 of the surface 2 into the data processor 26. The measurement data D14, D15 of the surface 2 were acquired at different time points t*, t**.

In the second step S2, it is determined whether the roughness R* of the surface 2 at the first time point t* is higher or lower than the lattice constant G14, G15 of the photodetectors 14, 15. Preferably, the roughness R* of the surface 2 at the first time point t* is determined visually or haptically. In this way, a human operator of the sensor device 10 is able to determine the roughness R* of the surface at the first time point t* by visual assessment or haptic assessment. The operator is able to assess whether the roughness R* of the surface at the first time point t* comprises coarse structures and whether it is greater than the lattice constant G14, G15, or whether it comprises fine structures and is smaller than the lattice constant G14, G15. The roughness R* of the surface 2 determined at the first time point t* is provided to the evaluation program CP. Preferably, the roughness R* of the surface 2 determined at the first time point t* is entered into the evaluation unit 20 via the input device 28. The input device 20 may be a keyboard or a touch screen for this purpose. For a roughness R* of the surface at the first time point t* that features coarse structures, the operator may enter a value "coarse" which means that the roughness R* of the surface 2 at the first time point t* is greater than the lattice constant G14, G15. For a roughness R* of the surface at the first time point t* featuring fine structures, the operator may enter a value "fine" which means that the roughness R* of the surface 2 at the first time point t* is smaller than the lattice constant G14, G15. The roughness R* of the surface 2 at the first time point t* entered via the input device 28 can be stored in the data memory 27 by the evaluation program CP. The roughness R* of the surface 2 at the first time point t* entered via the input device 28 can be loaded into the data processor 26 by the evaluation program CP.

In the third step S3, an amplitude A* of the measurement data D14, D15 of the surface 2 for a first time point t* and a further amplitude A** of the measurement data D14, D15 of the surface 2 for a further time point t** are extracted from the intensity I of the measurement data D14, D15 of the surface 2 by the evaluation program CP.

In the fourth step S4, the normalization data ND comprising the maximum amplitude MA are provided. To this end, the evaluation program CP loads the normalization data ND into the data processor 26.

In the fifth step S5, the evaluation program CP compares the normalization data ND to the amplitudes A*, A** extracted at the time points t*, t**. In this process, the evaluation program CP determines whether the amplitudes A*, A** extracted decrease over the time points t*, t**, or whether the amplitudes A*, A** extracted remain constant over the time points t*, t**, or whether the amplitudes A*, A** extracted increase over the time points t*, t**.

In the case when the roughness R* of the surface 2 at the first time point t* is higher than the lattice constant G14, G15, the evaluation program CP concludes from a decrease in the amplitudes A*, A** extracted that the roughness R** of the surface 2 at the time point t** is higher while the evaluation program CP concludes from an increase in the amplitudes A*, A** extracted that the roughness R** of the surface 2 at the time point t** is smaller.

When the amplitudes A*, A** extracted are constant over the time points t*, t**, the evaluation program CP concludes that the roughness R** of the surface 2 at the time point t** is unchanged as compared to the roughness R* of the surface 2 at the time point t*.

In the case when the roughness R* of the surface 2 at the first time t* is smaller than the lattice constant G14, G15, the evaluation program CP concludes from a decrease in the amplitudes A*, A** extracted that the roughness R** of the surface 2 is smaller at the time point t** while the evaluation program CP concludes from an increase in the amplitudes A*, A** extracted that the roughness R** of the surface 2 is higher at the time point t**.

The evaluation program CP is able to store the estimated change in roughness R*, R** at the time points t*, t** in the data memory 27. The evaluation program CP is able to output the estimated change in roughness R*, R** at the time points t*, t** on the output device 29.

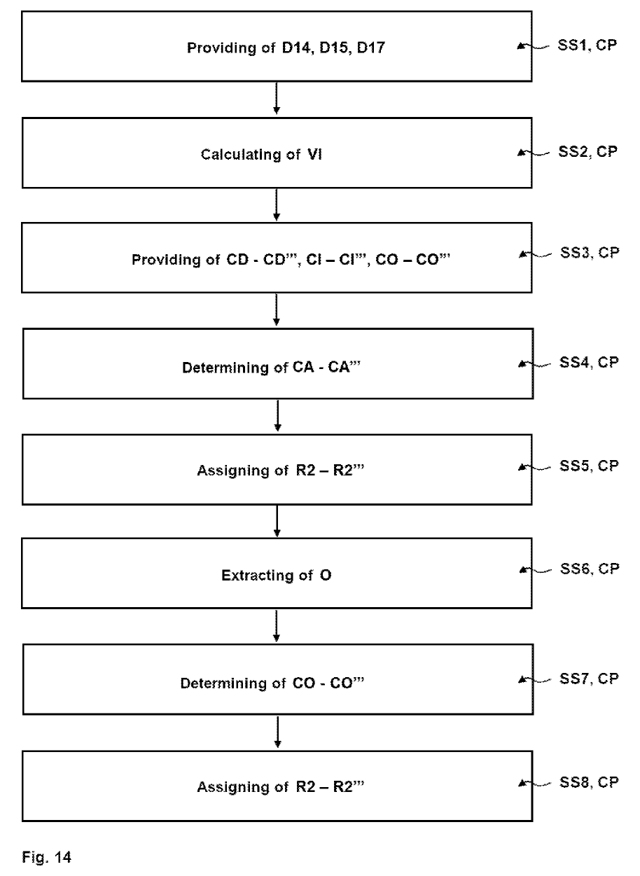

FIG. 14 shows steps SS1 to SS8 of a second variation of the process for determining the roughness R of the surface 2 using the sensor device 10 that includes a reference photodiode 17, 17' as shown in FIGS. 4, 5 and 7. In the second variation of the process, the roughness R is no longer estimated but is determined by eliminating the information on the light intensity L of the surface 2 in the intensity I of the first and second measurement data D14, D15 of the surface 2. Thereby, the second variation of the process is more accurate than the first variation of the process. Steps SS1 - SS7 of the second variation of the process comprise a first step SS1, a second step SS2, a third step SS3, a fourth step SS4, a fifth step SS5, an optional sixth step SS6, an optional seventh step SS7, and an optional eighth step SS8.

In the first step SS1, the measurement data D14, D15 of the surface 2 and the light intensity data D17 for these first and second measurement data D14, D15 of the surface 2 are provided. For this purpose, the evaluation program CP loaded into the data processor 26 is configured to load the measurement data D14, D15 of the surface 2 and the light intensity data D17 for these first and second measurement data D14, D15 of the surface 2 into the data processor 26.

In the second step SS2, the evaluation program CP is taking advantage of the sensor device 10 that includes a reference photodiode 17, 17' as shown in FIGS. 4, 5 and 7 and is configured to subtract the intensity 117 of the light intensity data D17 from the intensity I of the measurement data D14, D15 of the surface 2. The subtraction results in a corrected intensity VI of the measurement data D14, D15 from which the information on the light intensity L of the surface 2 has been eliminated and which now only comprise the information on the roughness R of the surface 2.

In the third step SS3, the calibration data CD - CD"' are provided. For this purpose, the evaluation program CP loads the calibration data CD - CD"' into the data processor 26.

In the fourth step, SS4, the evaluation program CP compares the calibration data CD - CD"' to the corrected intensity VI. From the calibration data CD - CD"', the evaluation program CP determines a calibration intensity CI - CI"' for the corrected intensity VI which calibration intensity CI - CI"' determined shows a smallest deviation regarding amount and shape from the corrected intensity VI.

In the fifth step SS5, the evaluation program CP assigns to the corrected intensity VI, the roughness R2 - R2"' of the calibration intensity CI - CI"' that was determined.

The sixth step SS6, the seventh step SS7, and the eighth step SS8 are optional which means that they are not strictly required for determining the roughness R2 - R2"'.

In the sixth step SS6, the evaluation program CP extracts the offset O from the intensity I of the measurement data D14, D15 of the surface 2. In the seventh step SS7, the evaluation program CP determines a calibration offset CO - CO"' of the calibration data CD - CD"' for the extracted offset O which calibration offset CO - CO"' determined shows a smallest deviation regarding amount and shape from the extracted offset O. In the eighth step SS5, the evaluation program CP assigns to the extracted offset o, the roughness R2 - R2"' of the calibration offset CO - CO"' that was determined to.

For a roughness R that is less than the lattice constants G14 and G15, the offset O is small. For a roughness R that is greater than the lattice constants G14 and G15, the offset O increases with the size of the structures K of the roughness R. The determination of the roughness R is verified when the roughness R2 - R2"' assigned to the calibration offset CO - CO"' determined in steps SS6 to SS7 is equal to the roughness R2 - R2"' assigned to the calibration intensity CI - CI"' determined in steps SS3 and SS4.

The evaluation program CP is configured to output the assigned roughness R2 - R2"' on the output device 29.

### LIST OF REFERENCE NUMERALS

1 vehicle

2 surface

3 roadway

10 sensor device

11 light

12 optical lens

13 aperture

14 first photodetector

14i first photodiode

15 second photodetector

15i second photodiode

16 axis of symmetry

17, 17' light intensity photodiode

20 evaluation unit

21 first subtractor

211, 212 first signal inputs

22 second subtractor

221, 222 second signal inputs

23 first analog-to-digital converter

24 second analog-to-digital converter

25 third analog-to-digital converter

251 third signal input

26 data processor

27 data memory

28 input device

29 output device

a photodetector angle

A, A2 -A2"', A*, A** amplitude CA - CA"' calibration amplitude

CD - CD"' calibration data

CO - CO"' calibration offset

CP evaluation program

D14 first measurement data

D15 second measurement data

D17 light intensity data

G14 first lattice constant

G15 second lattice constant

i index

1, 12 - 12"' intensity

117 light intensity

K, K2 - K2"' structure of roughness

L light intensity

M image scale

MA maximum amplitude

n plurality

ND normalization data

0, 02 - 02"' offset

P2 image of surface

R, R2 - R2"', R*, R** roughness of surface S1 - S5 process step

SS1 - SS8 process step

S14i first measurement signal

S14p first even-numbered measurement signal

S14u first odd-numbered measurement signal

S15i second measurement signal

S15p second even-numbered measurement signal

S15u second odd-numbered measurement signal

S17 light intensity signal

t time

t*, t** time point

T2 - T2"' period length

X14 first differences in potential

X15 second differences in potential

V speed

V12 - V12"' corrected intensity

What is claimed is:

1. A process for determining the roughness of a surface of a roadway, the process comprising the following steps:
moving a vehicle over the roadway, wherein the vehicle carries a sensor device that includes a photodetector;
capturing a portion of the surface of the roadway as an image on the photodetector;
generating measurement analog signals by the photodetector from the image captured on the photodetector;
converting the analog measurement signals generated by the photodetector into measurement digital data;
wherein said measurement digital data includes an intensity;
wherein the intensity contains information regarding the roughness of the surface;
wherein the intensity contains information regarding the light intensity of the surface; and
wherein the intensity of the measurement digital data is composed of an amplitude and an offset.

2. The process according to claim 1, wherein the analog signals are generated by the photodetector at a rate of at least 1,000 per second.

3. The process according to claim 1, further comprising the step of determining whether the roughness of the surface at a first time point is smaller or greater than a lattice constant of the photodetector.

4. The process according to claim 3, further comprising the step of extracting a first amplitude from the intensity for measurement digital data at the first time point;
extracting a further amplitude from the intensity for measurement digital data at a further time point;
providing a maximum amplitude of the sensor device;
determining whether the extracted further amplitude has decreased by the further time point, or whether the extracted further amplitude has remained constant by the further time point, or whether the extracted amplitude has increased by the further time point.

5. The process according to claim 4, wherein in the case when the roughness of the surface at the first time point is greater than the lattice constant, then a decrease in the amplitudes extracted is taken to mean that a roughness of the surface at the time point is greater, and an increase in the amplitudes extracted is taken to mean that a roughness of the surface at the time point is smaller;
wherein, when the amplitudes extracted at the time points are constant, then the roughness of the surface at the time point is unchanged as compared to the roughness of the surface at the time point; and
wherein when the roughness of the surface at the first time point is smaller than the lattice constant, then a decrease in the extracted amplitudes is taken to mean that a roughness of the surface at the time point is smaller, and an increase in the extracted amplitudes is taken to mean that a roughness of the surface at the time point is greater.

6. The process according to claim 1, wherein the sensor device includes a light intensity photodiode that is used to generate a light intensity analog signal for the light intensity of the surface, which light intensity analog signal has an intensity;
converting the light intensity analog signal into light intensity digital data;
providing the light intensity digital data; and
taking the intensity of the light intensity digital data into account regarding the intensity of the measurement digital data of the surface in a manner that provides a corrected intensity of the measurement digital data.

7. The process according to claim 6, further comprising the step of providing calibration data that includes calibration intensities for different roughnesses of a surface;
determining a calibration intensity for the corrected intensity that shows the smallest deviation in amount and shape from the corrected intensity; and
assigning the corrected intensity to the roughness of the calibration intensity that is determined.

8. The process according to claim 7, further comprising extracting the offset from the intensity of the measurement data;
determining a calibration offset from the calibration data for the extracted offset that shows the smallest deviation in amount and shape from the extracted offset;
assigning the roughness of the determined calibration offset to the extracted offset.

9. A sensor device for being carried on a vehicle while determining the roughness of a surface of a roadway on which the vehicle is traveling, the sensor device comprising:
a photodetector configured to be carried on the vehicle while pointed at the roadway for imaging a portion of the surface onto the photodetector as an image;
wherein the photodetector is configured to generate measurement analog signals from the image;
an evaluation unit configured to convert the measurement analog signals into measurement digital data;
an evaluation program configured to load and evaluate the measurement digital data;
wherein the measurement digital data includes an intensity that contains information regarding the roughness of the surface and information regarding the light intensity of the surface; and
wherein the intensity of the measurement digital data is composed of an amplitude and an offset.

10. The sensor device according to claim 9, wherein the evaluation program is configured to operate on the measurement digital data to determine whether a roughness of the surface at a first time point is smaller or greater than a lattice constant of the photodetector.

11. The sensor device according to claim 10, wherein the evaluation program is configured to extract an amplitude from the intensity for measurement digital data at the first time point and extract a further amplitude from the intensity for measurement digital data at a further time point.

12. The sensor device according to claim 11, wherein the evaluation program is configured to load a maximum amplitude of the sensor device;
wherein the evaluation program is configured to determine whether the amplitudes extracted decrease over the time points, or whether the amplitudes extracted remain constant over the time points, or whether the amplitudes extracted increase over the time points.

13. The sensor device according to claim 12, wherein the evaluation program is configured so that when the roughness of the surface at the first time point is greater than the lattice constant, then the evaluation program is configured to conclude from a decrease in the amplitudes extracted that a roughness of the surface at the first time point is greater and to conclude from an increase in the amplitudes extracted that a roughness of the surface at the further time point is smaller;
wherein the evaluation program is configured so that when the amplitudes extracted are constant over the time points, then the evaluation program is configured to conclude that the roughness of the surface at the further time point is unchanged as compared to the roughness of the surface at the first time point; and
wherein the evaluation program is configured so that in the case when the roughness of the surface at the first time point is smaller than the lattice constant, then the evaluation program is configured to conclude from a decrease in the amplitudes extracted that a roughness of the surface at the first time point is smaller and to conclude from an increase in the amplitudes extracted that a roughness of the surface at the further time point is higher.

14. The sensor device according to claim 9, further comprising a light intensity photodiode configured to generate a light intensity analog signal for the light intensity of the surface, which light intensity analog signal comprises an intensity;
wherein the evaluation unit is configured to convert the light intensity analog signal into light intensity digital data;
wherein the evaluation program is configured to load the light intensity digital data and evaluate the loaded light intensity data; and
wherein the evaluation program is configured to subtract the intensity of the light intensity digital data from the intensity of the measurement digital data of the surface and thus obtain a corrected intensity of the measurement digital data.

15. The sensor device according to claim 14, wherein the evaluation program is configured to load calibration data that include calibration intensities for different roughnesses of a surface; and
wherein the evaluation program is configured to determine a calibration intensity for the corrected intensity, which calibration intensity determined shows the smallest deviation in amount and shape from the corrected intensity.

16. The sensor device according to claim 15, wherein the evaluation program is configured to assign the determined roughness of the calibration intensity to the corrected intensity.

17. The sensor device according to claim 16,
wherein the evaluation program is configured to extract the offset from the intensity of the measurement data;wherein the evaluation program is configured to determine a calibration offset of the calibration data for the offset extracted, which determined calibration offset shows the smallest deviation in amount and shape from the extracted offset; and
wherein the evaluation program is configured to assign the determined roughness of the calibration offset to the extracted offset.
